(19) United States
(12) Patent Application Publication
(10) Pub. No.: US 2026/0140701 A1
(43) Pub. Date: May 21, 2026

(54) REDUCED SIZE ARITHMETIC UNIT FOR MULTIPLICATION AND DIVISION

(71) Applicant: NORTHROP GRUMMAN SYSTEMS CORPORATION, FALLS CHURCH, VA (US)

(72) Inventors: KYLE DAVID SHIFLETT, Baltimore, MD (US); BRIAN R. KONIGSBURG, Pasadena, MD (US)

(21) Appl. No.: 18/954,598

(22) Filed: Nov. 21, 2024

(51) Int. Cl. G06F 7/57; G06F 7/487

(52) U.S. Cl. CPC G06F 7/57; G06F 7/487

(57) ABSTRACT

An arithmetic unit implemented as an integrated circuit includes control logic configured to receive a control input representing a multiplication operation or a division operation and configure significand logic to perform a selected one of the multiplication operation and the division operation. The significand logic is configured to receive a first operand and a second operand and perform the selected operation on at least a portion of the first operand and at least a portion of the second operand.

### GOVERNMENT INTEREST

The invention was made under Government Contract. Therefore, the US Government has rights to the invention as specified in that contract.

### TECHNICAL FIELD

The present invention relates to computer processors, and more particularly, to a reduced size arithmetic unit for multiplication and division.

### BACKGROUND

In area-constrained processors, performance is often sacrificed to maintain required functionality. Floating-point multiplication and division and integer multiplication can occupy a large footprint, especially with wide bit-width operands, such as sixty-four bit operations. In one extreme, small arithmetic units performing sequential algorithms can be used to keep area to a minimum. These small, sequential arithmetic units are not performant. In the other extreme, large arithmetic units performing parallel algorithms can be used to keep performance to a maximum. However, depending on area constraints, these large arithmetic units may be infeasible or impractical. Their large footprint may require the degradation or removal of other logic in the processor to create enough space to fit for designs with a fixed die area budget. Also, their large footprint may increase die size beyond the point of what is reasonable for cost.

### SUMMARY OF THE INVENTION

In one aspect of the present invention, an arithmetic unit implemented as an integrated circuit includes control logic configured to receive a control input representing a multiplication operation or a division operation and configure significand logic to perform a selected one of the multiplication operation and the division operation. The significand logic is configured to receive a first operand and a second operand and perform the selected operation on at least a portion of the first operand and at least a portion of the second operand.

In another aspect of the present invention, a method includes receiving a first operand, a second operand, and a control input representing either a multiplication operation or a division operation at an arithmetic unit. Significand logic associated with the arithmetic unit is configured to perform a selected one of the multiplication operation and the division operation. The selected one of the multiplication operation and the division operation is performed on at least a portion of the first operand and at least a portion of the second operand.

In a further aspect of the present invention, an arithmetic unit implemented as an integrated circuit includes control logic configured to receive a control input representing a selected one of a floating-point division operation, a floating-point multiplication operation, and an integer multiplication operation and to configure significand logic to perform the selected operation. The significand logic is configured to receive a first operand and a second operand and perform the selected operation on at least a portion of the first operand and at least a portion of the second operand.

### BRIEF DESCRIPTION OF THE DRAWINGS

FIG. 1 illustrates an arithmetic unit implemented as an integrated circuit;

FIG. 2 illustrates one example of an arithmetic unit that can perform any of floating-point multiplication, floating-point division, or integer multiplication;

FIG. 3 illustrates one implementation of the significand logic of FIG. 2 that implements the Goldschmidt method for division operations;

FIG. 4 illustrates a method for performing a division operation or a multiplication operation using a reduced size arithmetic unit; and

FIG. 5 illustrates another method for performing a division operation or a multiplication operation using a reduced size arithmetic unit.

### DETAILED DESCRIPTION

Floating-point multiplication,” as used herein, refers to multiplication of real numbers that are each represented by an integer with fixed precision, called a significand, that is scaled by a base value, also represented as an integer.

“Floating-point division,” as used herein, refers to division of real numbers that are each represented by a significand that is scaled by a base value represented as an integer.

The systems and methods described herein reduce the area burden of large arithmetic units through their combination, providing a novel and effective trade-off between area and performance. Area reduction is achieved by sharing the significand logic between floating-point multiplication, floating-point division, and integer multiplication operations. In some implementations, performance is maintained through the scheduled interleaving of arithmetic operations in the execution unit pipeline. The systems and methods described herein could potentially reduce floating-point unit (FPU) area by a factor of two. Based on market estimates, the price per 300 mm wafer using common processes is approximately $20,000. An FPU generally occupies approximately twenty percent of the central processing unit (CPU) core area, and reducing the FPU area by a factor of two could lead to an overall die area reduction of approximately five percent. This would increase the number of dies per wafer, and thus the cost per die, by a corresponding amount. The cost per die can be reduced further when factoring in yield improvements due to smaller dies. It will be appreciated that this percentage can change depending on the architecture of the chips being manufactured, particularly based on the ratio of space used for execution units to space used for caches on the chip.

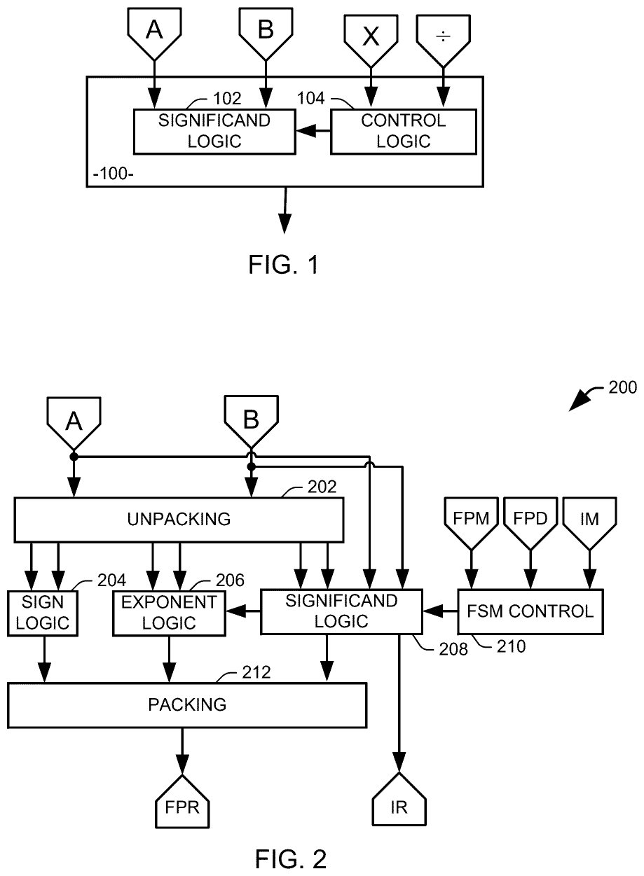

FIG. 1 illustrates an arithmetic unit implemented as an integrated circuit. The arithmetic unit 100 includes control logic 102 configured to receive a control input representing either a multiplication operation or a division operation and configure significand logic 104 to perform the selected one of the multiplication operation and the division operation on all or a portion of a first operand, A, and a second operand, B. In one implementation, the control input can represent any of a floating-point division operation, a floating-point multiplication operation, and an integer multiplication operation. It will be appreciated that while the significand logic 104 can directly perform multiplication of integer operands, the arithmetic unit 100 can include additional logic (not shown) for isolating the various portion of the significand portion of floating-point inputs. In one example, an unpacking block (not shown) can accept a floating-point operand and produces a sign output, an exponent value, and a significand value, with first and second inputs for the first and second operands, a first and second sign outputs, first and second exponent outputs, and first and second significand outputs. These outputs can be provided to sign logic (not shown) that produces a sign of a floating point result from the sign outputs, exponent logic (not shown) that produces an exponent portion of a floating point result from the exponent outputs, and the significant logic 104. The sign, exponent portion, and significand portion of a floating-point result can be repacked into a floating-point representation at a packing block (not shown).

The significand logic 104 is configured to receive the first operand and the second operand and perform the multiplication operation or the division operation on at least a portion of the first operand and at least a portion of the second operand. In one example, the significand logic 104 includes operand selection logic that receives the first operand, the second operand, a first significand representing the first operand, a second significand representing the second operand, and a control signal from the control logic 102 representing a selected one of the multiplication operation and the division operation. For integer multiplication, the operand selection logic can select the first operand and the second operand, and for floating-point multiplication or division, the operand selection logic selects the first significand and the second significand. It will be appreciated that the significand logic can perform the floating-point division as an iterative algorithm, and that in this instance, the operand selection logic can further receive a division initialization value during a first iteration and the result of a previous iteration during subsequent iterations. The divide initialization value can be provided by divide initialization logic. In one example, the divide initialization logic is implemented using a direct reciprocal lookup table.

In one example, the significand logic can include a partial product tree that computes a plurality of values representing a product of the at least a portion of the first operand and the at least a portion of the second operand. For example, the output of the partial product tree can be a redundant binary representation with separate carry and sum values. The partial product tree can be used for directly for multiplication operations or for multiplication steps in an iterative division algorithm. One or more adders can be included to generate a sum of the plurality of values. In one example, a carry-save adder adds an injected rounding bit vector to at least one of the plurality of values during the division operation and a carry-propagate adder sums the plurality of values. In this implementation, a zero-sum detector that detects when a zero-sum occurs in the carry-propagate adder. Normalization and rounding logic generates a normalized product from the output of the adders, which can be either a final result for an operation or an intermediate result during the iterative division algorithm. In this example, the control logic 102 directly configures the operand selection logic, a bit injector that provides the rounding bit vector, and the normalization and rounding logic according to the selected operation, with the operands selected as described above, the bit injector active only during division iterations, and the normalization and rounding following different rules for division and multiplication. Otherwise, the entire significand logic 104 operates in the same manner regardless of the operation.

FIG. 2 illustrates one example of an arithmetic unit 200 that can perform any of floating-point multiplication, floating-point division, or integer multiplication. The arithmetic unit 200 accepts five inputs and produces two outputs, a floating-point result, FPR, and an integer result, IR. The first two inputs are the two operands, A and B, for the floating-point multiplication, floating-point division, or the integer multiplication operation. In the illustrated implementation, floating-point operands can be formatted as an IEEE-754 standard compliant floating-point number or in a similar format which contains a sign bit, and exponent field, and a significand field. Integer operands are represented as signed two's complement integers. The other three inputs are enable signals which indicate the operation to perform on the input operands, specifically a floating-point multiply enable signal, FPM, a floating-point divide signal, FMD, and an integer multiply signal, IM.

An unpacking block 202 produces the sign, exponent, and significand fields of each operand. The sign of each operand is provided to sign logic 204 that produces the sign of the result. In one implementation, the calculation is performed using an XOR gate. Exponent logic 206 receives the exponent fields from each operand and generates the exponent field of the result. In the illustrated example, the exponent logic receives the exponent inputs in two's complement notation and performs the appropriate operation, for example, an addition operation for the multiplication operation and a subtraction operation for the division operation. A bias offset can be applied, with the bias subtracted from the product of a multiplication and added to the quotient of a division. The product of a multiplication can be incremented based on normalization and round up from the significand operation, whereas, the quotient of a division operation can be decremented during normalization or can be incremented during round up. The exponent is speculatively incremented and decremented in parallel, and the correct exponent value is chosen once the shift amount and shift direction from the significand logic is known.

The exponent logic 206 can also detect overflow and underflow in the resulting value. For division operations, underflow is detected when the sum of the two exponents is less than the bias value and an overflow is detected when the difference between the exponents exceeds the sum of the bias and one. Once the bias is added and any contribution from the significand logic has been added, a value of all zeros indicates that underflow has occurred, and a value of all ones indicates that overflow has occurred. For multiplication operations, underflow is detected when the difference between the two exponents is less than or equal to the additive inverse of the bias value and an overflow is detected when the sum of the exponents exceeds the sum of three times the bias and one. Once the bias is subtracted and any contribution from the significand logic has been accounted for, a value of all zeros indicates that underflow has occurred, and a value of all ones indicates that overflow has occurred. The comparisons are done regarding two's complement notation. If doing a division, and the sign, represented by the most significant bit (MSB), of the exponent and the compared constant are different, then the MSBs of both are flipped so the result of <, =, and > remain correct using unsigned comparators.

Significand logic 208 produces the significand field of the floating-point result for the floating-point multiplication or the floating-point division operation, and the integer result for integer multiplication. A finite state machine (FSM) control 210 contains the finite state machine that configures the significand logic 208 for the appropriate operation by producing various control signals for the significand logic based on the selected operation.

When appropriately configured via the FSM control 210, the significand logic 208 performs a floating-point division operation via an appropriate division algorithm. Most division algorithms belong to the digit-recurrence class, which produce a fixed number of quotient bits in every iteration of the algorithm. Digit-recurrent division algorithm hardware implementations generally have low complexity and low area overhead, but tend to have high latency. One example is the SRT division algorithm. Digit-recurrent division algorithms are linearly-convergent to the quotient, since they produce a fixed number of bits every iteration. To put the latency into perspective, a digit-recurrent algorithm computing the quotient of two fifty-three bit significands might retire two bits of the quotient each iteration, but require two cycles per iteration, meaning fifty-three cycles are needed before the quotient is computed.

To reduce division latency, faster convergence to the quotient is needed. Fast division algorithms mostly belong to the functional iteration class, which use multiplication as the fundamental operation, as opposed to subtraction in the common digit-recurrent algorithms. The significand logic 208 can use any appropriate division algorithm, including the Newton-Raphson method, a root-finding method, and the Goldschmidt method, which is a series-expansion method. Both Newton and Goldschmidt methods are quadratically-convergent, which means they produce an increasing number of quotient bits each iteration of the algorithm. More intuitively explained, in binary systems, a quadratically-convergent algorithm will roughly or exactly double the number of accurate digits each iteration. This allows for much faster division, at the cost of higher hardware complexity and area.

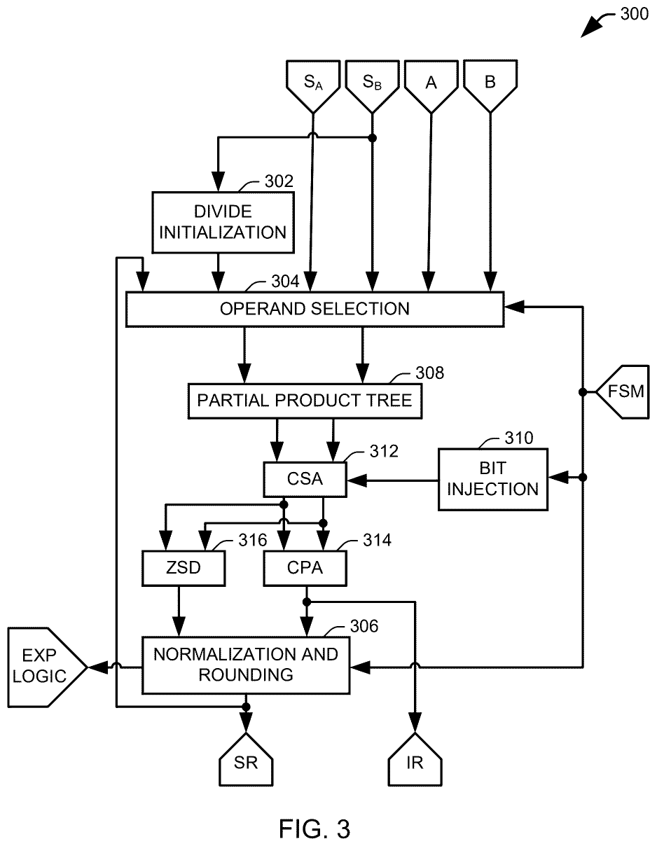

FIG. 3 illustrates one implementation of the significand logic 208 of FIG. 2 that implements the Goldschmidt method for division operations. The algorithm initializes its approximate numerator, N′, using the real numerator of the division, A. Similarly, the approximate denominator D′ is initialized with the real denominator of the division, B. The approximate scale factor F′ is initialized to some approximation of the reciprocal

$${x}_{0} \approx \frac{1}{B} .$$

Each iteration, the numerator and denominator are refined by F′, which causes N′ to converge towards A/B, and D′ to converge towards 1. The computation of N′ and D′ require one multiplication each, and the computation of F′ requires a two's complement of D′. (2-D′) is equivalent to the two's complement of D′. The values nᵢ, dᵢ, and fᵢ are the relative errors, which correspond to the bit widths of their operands. In each iteration, the multiplications yielding N′ᵢ and D′ᵢ are independent, and therefore can be either pipelined through a single multiplier, or computed in parallel using two separate multipliers. The two's complement operation to calculate F′ᵢ would generally require an adder or incrementor, however, in the illustrated example, this is implemented using one's complement (inversion) which introduces a constant error of −1 units in the last place.

Divide initialization logic 302 produces a division seed x₀ for the Goldschmidt algorithm. In the illustrated implementation, the algorithm is initialized by using an initial approximation of

$${x}_{0} \approx \frac{1}{B}$$

as the seed. Inis can be obtained several ways, and in the illustrated implementation, the seed is generated from a direct reciprocal lookup table.

Operand selection logic 304 selects inputs based on the current operation, as indicated by the FSM control 210. When integer multiplication is selected, the two operands, A and B, are selected. For floating-point multiplication and the first floating-point division iteration, the floating-point significands S_{A} and S_{B}, are selected for the first floating-point division iteration or for floating-point multiplication, with the division seed selected during the first floating-point division iteration. For subsequent division iterations, the feedback path from the normalization and rounding block 306 is selected. A feedback path is used after normalization and rounding to pass previous iteration Nᵢ and Dᵢ values. It will be appreciated that the operand selection logic 304 can include exception handling logic that can detect invalid input combinations, such as division by zero.

The selected inputs are provided to a partial product tree (PPT) 308 that accepts two N-bit operands, performs multiplication on them, and produces a product in a redundant binary representation, represented as a carry and a sum. In the illustrated implementation, the partial product tree 308 is implemented as a signed PPT to support signed integer multiplication. A width of the singed PPT operand width is selected to be at least one bit wider than is needed for unsigned multiplication, which, in turn, depends on the internal precision required for the division algorithm. In one example, the partial product tree 308 is implemented as a Baugh-Wooley multiplier.

Bit Injection logic 310 is used for injection-based rounding in the division iterations, and is selected for division operations by the FSM control 210. A 3:2 carry-save adder (CSA) 312 adds in the rounding injection as a bit vector to the redundant binary representation result of the partial product tree 308, outputting carry and sum values with the rounding bit vector added when the bit injection is active during division. The carry save adder 312 simply passes the carry and sum values during multiplication operations. A carry-propagate adder (CPA) 314 produces the final sum of the product and rounding injection from the carry and sum values. The carry-propagate adder 314 can be implemented as a standard two's complement adder that adds two operands with an optional carry-in, and produces one result with a carry-out. The sign of the adder result can be used to determine if the division remainder is positive or negative during back-multiplication. For integer multiplication, the output of the carry-propagate adder can be provided as the result of the integer operation, IR. A zero-sum detector (ZSD) 316 detects when a zero-sum occurs in the carry-propagate adder 314. The zero-sum detector 316 can be used to implement various rounding modes at the normalization and rounding block 306.

The normalization and rounding block 306 produces a correctly-rounded and normalized significand, SR, from the output of the carry-propagate adder 314. In the illustrated example, normalization involves bit-shifting the significand, and rounding is performed as a round to nearest value, with ties to even. Normalization requires a small left/right shifter for products and quotients. The subtraction result of back-multiplication does not get normalized, as only the sign bit is useful, keeping normalization simple. Multiplication might require one right shift, either for product normalization or if rounding up overflows. Division might require one left shift for quotient normalization and one right shift if rounding up overflows. Any overflow detected during the normalization and rounding process is sent to the exponent logic 206 to adjust the result of the exponent calculation appropriately.

Table 1 illustrates an example timing diagram for a floating-point division operation. The timing diagram assumes that the divide initialization approximation takes one clock cycle, and the multiplication takes four clock cycles, represented as stages S0-S3. It also assumes that the Goldschmidt division algorithm yields the result within sufficient error bounds after three iterations. Each Dᵢ and Nᵢ step is shown.

TABLE 1

| | | Cycle | | | | | | | | | | | | | | |
|---|---|---|---|---|---|---|---|---|---|---|---|---|---|---|---|---|
| | | 0 | 1 | 2 | 3 | 4 | 5 | 6 | 7 | 8 | 9 | 10 | 11 | 12 | 13 | 14 |
| FDIV 0 | Appx | A | | | | | | | | | | | | | | |
| | D₀ | | S0 | S1 | S2 | S3 | | | | | | | | | | |
| | N₀ | | | S0 | S1 | S2 | S3 | | | | | | | | | |
| | D₁ | | | | | | | S0 | S1 | S2 | S3 | | | | | |
| | N₁ | | | | | | | | S0 | S1 | S2 | S3 | | | | |
| | N₂ | | | | | | | | | | | | S0 | S1 | S2 | S3 |

Since floating-point division, floating-point multiplication, and integer multiplication all use the same significand logic block, multiple operations can be interleaved between division iterations to keep utilization of the arithmetic unit high. Table 2 illustrates two division operations, FDIV 0 and FDIV 1, interleaved with two floating-point multiply operations, FMUL 0 and FMUL 1, and an integer multiply operation, IMUL 0.

TABLE 2

| | | Cycle | | | | | | | | | | | | | | | | |
|---|---|---|---|---|---|---|---|---|---|---|---|---|---|---|---|---|---|---|
| | | 0 | 1 | 2 | 3 | 4 | 5 | 6 | 7 | 8 | 9 | 10 | 11 | 12 | 13 | 14 | 15 | 16 |
| FDIV 0 | Appx | A | | | | | | | | | | | | | | | | |
| | D₀ | | S0 | S1 | S2 | S3 | | | | | | | | | | | | |
| | N₀ | | | S0 | S1 | S2 | S3 | | | | | | | | | | | |
| FDIV 1 | Appx | | | A | | | | | | | | | | | | | | |
| | D₀ | | | | S0 | S1 | S2 | S3 | | | | | | | | | | |
| | N₀ | | | | | S0 | S1 | S2 | S3 | | | | | | | | | |
| FMUL 0 | | | | | | | S0 | S1 | S2 | S3 | | | | | | | | |
| FDIV 0 | D₁ | | | | | | | S0 | S1 | S2 | S3 | | | | | | | |
| | N₁ | | | | | | | | S0 | S1 | S2 | S3 | | | | | | |
| FDIV 1 | D₁ | | | | | | | | | S0 | S1 | S2 | S3 | | | | | |
| | N₁ | | | | | | | | | | S0 | S1 | S2 | S3 | | | | |
| IMUL 0 | | | | | | | | | | | | S0 | S1 | S2 | S3 | | | |
| FDIV 0 | N₂ | | | | | | | | | | | | S0 | S1 | S2 | S3 | | |
| FMUL 1 | | | | | | | | | | | | | | S0 | S1 | S2 | S3 | |
| FDIV 1 | N₂ | | | | | | | | | | | | | | S0 | S1 | S2 | S3 |

Returning to FIG. 2, the outputs of the sign logic 204, the exponent logic 206, and the significand logic 208 are provided a packing block 212. The packing block 212 creates a packed floating-point number from these inputs as a floating-point result for the arithmetic unit.

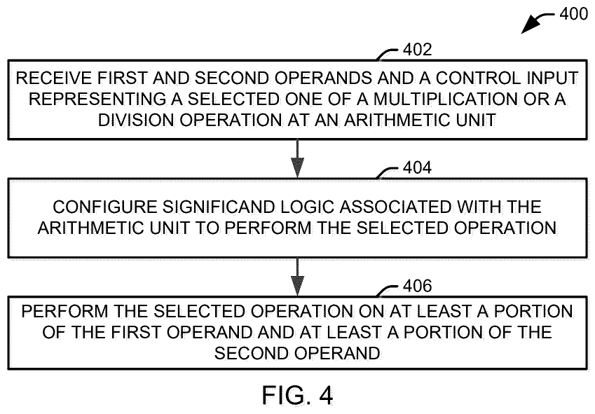

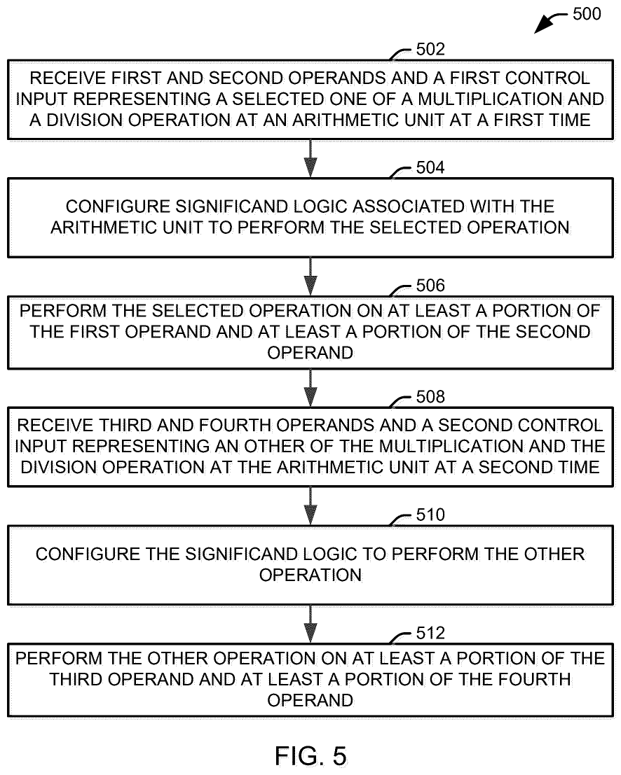

In view of the foregoing structural and functional features described above in FIGS. 1-3, example methods will be better appreciated with reference to FIGS. 4 and 5. While, for purposes of simplicity of explanation, the methods of FIGS. 4 and 5 are shown and described as executing serially, it is to be understood and appreciated that the present invention is not limited by the illustrated order, as some actions could in other examples occur in different orders and/or concurrently from that shown and described herein.

FIG. 4 illustrates one method for performing a division operation or a multiplication operation using a reduced size arithmetic unit. At 402, the arithmetic unit receives a first operand, a second operand, and a control input representing a selected one of a multiplication operation and a division operation. In one implementation, the control signal represents either a floating-point division operation, a floating-point multiplication operation, or an integer multiplication operation, and the first and second operands can be floating-point values or integers. At 404, significand logic associated with the arithmetic unit is configured to perform the selected operation. For example, an operand selection block can be configured to select all or a portion of the operand as inputs for significand logic associated with the arithmetic unit, and logic within the significand logic can be configured to either multiply all or a portion of the two inputs (e.g., the significands of floating-point inputs) or perform one iteration of a division algorithm for all or a portion the two inputs. At 406, the selected operation is performed on at least a portion of the first operand and at least a portion of the second operand. For example, two integer operands can be multiplied to provide an integer result, or the significands of two floating-point operands can be multiplied or divided to provide a significand for a floating-point result.

FIG. 5 illustrates another method 500 for performing a division operation or a multiplication operation using a reduced size arithmetic unit. At 502, the arithmetic unit receives a first operand, a second operand, and a first control input representing a selected one of a multiplication operation or a division operation at a first time. At 504, significand logic associated with the arithmetic unit is configured to perform the selected operation. It will be appreciated the configuration of the significand logic can include only those portions of the significand logic needed for the selected operation during a given clock cycle. For example, an operand selection block can be configured to select all or a portion of the operand as inputs for significand logic associated with the arithmetic unit, and one or both of bit injection logic and normalization and rounding logic within the significand logic can be configured to either multiply all or a portion of the two inputs (e.g., the significands of floating-point inputs) or perform one iteration of a division algorithm for all or a portion the two inputs. At 506, the selected operation is performed on at least a portion of the first operand and at least a portion of the second operand. For example, two integer operands can be multiplied to provide an integer result, or the significands of two floating-point operands can be multiplied or divided to provide a significand for a floating-point result.

At 508, a third operand, a fourth operand, and a second control input representing an other of the multiplication operation and the division operation at the arithmetic unit at a second time. For example, the inputs could be received in a next clock cycle of the arithmetic unit. At 510, a portion of the significand logic is configured to perform the other of the multiplication operation and the division operation. Again, it will be appreciated that not all of the significand logic may be involved in a given operation for a given clock cycle, and that configuration for the other of the multiplication operation and the division operation can be limited to less than all of the elements of the significand logic that is configurable for different operations. At 512, the other of the multiplication operation and the division operation is performed on at least a portion of the third operand and at least a portion of the fourth operand.

Because not all of the significand logic is need for each step of an operation, it will be appreciated that operations can be interleaved with multiple operations occurring within the significand logic for any given clock cycle. This can include steps of different iterative floating-point divisions, floating-point multiplications, or integer multiplications. Accordingly, a multiplication operation and a division operation can be interleaved such that they overlap in time with one another, with different elements of the significand logic configured to perform each of the two operations during the same clock cycle.

Specific details are given in the above description to provide a thorough understanding of the embodiments. However, it is understood that the embodiments can be practiced without these specific details. For example, physical components can be shown in block diagrams in order not to obscure the embodiments in unnecessary detail. In other instances, well-known circuits, processes, algorithms, structures, and techniques can be shown without unnecessary detail in order to avoid obscuring the embodiments.

Also, it is noted that the embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in the figure. A process can correspond to a method, a function, a procedure, a subroutine, a subprogram, etc. When a process corresponds to a function, its termination corresponds to a return of the function to the calling function or the main function.

What have been described above are examples of the present invention. It is, of course, not possible to describe every conceivable combination of components or methodologies for purposes of describing the present invention, but one of ordinary skill in the art will recognize that many further combinations and permutations of the present invention are possible. While certain novel features of this invention shown and described below are pointed out in the annexed claims, the invention is not intended to be limited to the details specified, since a person of ordinary skill in the relevant art will understand that various omissions, modifications, substitutions and changes in the forms and details of the invention illustrated and in its operation may be made without departing in any way from the spirit of the present invention. Accordingly, the present invention is intended to embrace all such alterations, modifications, and variations that fall within the scope of the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements. No feature of the invention is critical or essential unless it is expressly stated as being “critical” or “essential.”

What is claimed is:

1. An arithmetic unit implemented as an integrated circuit, the arithmetic unit comprising:
control logic configured to receive a control input representing one of a multiplication operation and a division operation and configure significand logic to perform the one of the multiplication operation and the division operation; and
the significand logic, which is configured to receive a first operand and a second operand and perform the one of the multiplication operation and the division operation on at least a portion of the first operand and at least a portion of the second operand.

2. The arithmetic unit of claim 1, wherein the one of the multiplication operation and the division operation is one of a floating-point division operation, a floating-point multiplication operation, and an integer multiplication operation.

3. The arithmetic unit of claim 1, further comprising an unpacking block that accepts a floating-point operand and produces a sign output, an exponent value, and a significand value from the floating-point operand, the unpacking block comprising first and second inputs for the first and second operands, a first sign output, a second sign output, a first exponent output, a second exponent output, a first significand output, and a second significand output.

4. The arithmetic unit of claim 1, further comprising:
sign logic that determines a sign of a result of the one of the multiplication operation and the division operation from the first sign output and the second sign output; and
exponent logic that produces an exponent portion of the result of the one of the multiplication operation and the division operation from the first exponent output and the second exponent output.

5. The arithmetic unit of claim 4, further comprising a packing block that generates a floating-point value from an output of the significand logic, the sign of a result of the one of the multiplication operation and the division operation, and exponent portion of the result of the one of the multiplication operation and the division operation.

6. The arithmetic unit of claim 3, wherein the significand logic further comprises operand selection logic that receives the first operand, the second operand, the first significand output, the second significand output, and a control signal from the control logic representing the one of the multiplication operation and the division operation, the operand selection logic selecting the first operand and the second operand when the one of the multiplication operation and the division operation is an integer multiplication, and selecting the first significand output and the second significand output when the one of the multiplication operation and the division operation is one of a floating-point multiplication operation and a floating-point division operation.

7. The arithmetic unit of claim 1, wherein the significand logic comprises:
a partial product tree that computes a plurality of values representing a product of the at least a portion of the first operand and the at least a portion of the second operand;
at least one adder that generates a sum of the plurality of values; and
normalization and rounding logic that generates a normalized product, the normalized product being employed as a final result during the multiplication operation and as part of an iterative division algorithm during the division operation.

8. The arithmetic unit of claim 7, further comprising:
an unpacking block that accepts a floating-point operand and produces a sign output, an exponent value, and a significand value from the floating-point operand, the unpacking block comprising first and second inputs for the first and second operands, a first sign output, a second sign output, a first exponent output, a second exponent output, a first significand output, a second significand output; and
operand selection logic that receives the first operand, the second operand, the first significand output, the second significand output, the normalized product, and a control signal from the control logic representing the one of the multiplication operation and the division operation, the operand selection logic selecting the first operand and the second operand during an integer multiplication, selecting the first significand output and the second significand output during one of a floating-point multiplication operation and a first iteration of the iterative division algorithm, and selecting the normalized product during a second iteration of the iterative division algorithm.

9. The arithmetic unit of claim 7, wherein the at least one adder comprises:
a carry-save adder that adds an injected rounding bit vector to at least one of the plurality of values representing the product of the at least a portion of the first operand and the at least a portion of the second operand during the division operation; and
a carry-propagate adder that sums the plurality of values.

10. The arithmetic unit of claim 9, further comprising a zero-sum detector that detects when a zero-sum occurs in the carry-propagate adder.

11. The arithmetic unit of claim 1, the significand logic further comprising divide initialization logic that produces a division seed for the division operation.

12. The arithmetic unit of claim 11, wherein the divide initialization logic is implemented as a direct reciprocal lookup table.

13. A method comprising:
receiving a first operand, a second operand, and a control input representing one of a multiplication operation and a division operation at an arithmetic unit;
configuring significand logic associated with the arithmetic unit to perform the one of the multiplication operation and the division operation; and
performing the one of the multiplication operation and the division operation on at least a portion of the first operand and at least a portion of the second operand at the significand logic.

14. The method of claim 13, wherein receiving the first operand, the second operand, and the control input representing one of the multiplication operation and the division operation at the arithmetic unit, comprises receiving a first control input at a first time, the method further comprising:
receiving a third operand, a fourth operand, and a second control input representing an other of the multiplication operation and the division operation at the arithmetic unit at a second time;
configuring a portion of the significand logic to perform the other of the multiplication operation and the division operation; and
performing the other of the multiplication operation and the division operation on at least a portion of the third operand and at least a portion of the fourth operand.

15. The method of claim 13, wherein the one of the multiplication operation and the division operation is interleaved with the other of the multiplication operation and the division operation, such that performing the other of the multiplication operation and the division operation on at least a portion of the third operand and at least a portion of the fourth operand overlaps in time with performing the one of the multiplication operation and the division operation on at least a portion of the first operand and at least a portion of the second operand.

16. An arithmetic unit implemented as an integrated circuit, the arithmetic unit comprising:
control logic configured to receive a control input representing one of a floating-point division operation, a floating-point multiplication operation, and an integer multiplication operation and configure significand logic to perform the one of the floating-point division operation, the floating-point multiplication operation, and the integer multiplication operation; and
the significand logic, which is configured to receive a first operand and a second operand and perform the one of the floating-point division operation, the floating-point multiplication operation, and the integer multiplication operation on at least a portion of the first operand and at least a portion of the second operand.

17. The arithmetic unit of claim 16, wherein the significand logic performs the floating-point division operation via the Goldschmidt method.

18. The arithmetic unit of claim 16, wherein the significand logic comprises:
a partial product tree that computes a plurality of values representing a product of the at least a portion of the first operand and the at least a portion of the second operand;
at least one adder that generates a sum of the plurality of values; and
normalization and rounding logic that generates a normalized product, the normalized product being employed as a final result during either of the floating-point multiplication operation and the integer multiplication operation, and as part of an iterative division algorithm during the floating-point division operation.

19. The arithmetic unit of claim 18, further comprising:
an unpacking block that accepts a floating-point operand and produces a sign output, an exponent value, and a significand value from the floating-point operand, the unpacking block comprising first and second inputs for the first and second operands, a first sign output, a second sign output, a first exponent output, a second exponent output, a first significand output, a second significand output; and
operand selection logic that receives the first operand, the second operand, the first significand output, the second significand output, the normalized product, and a control signal from the control logic representing the one of the floating-point division operation, the floating-point multiplication operation, and the integer multiplication operation, the operand selection logic selecting the first operand and the second operand during the integer multiplication operation, selecting the first significand output and the second significand output during either of the floating-point multiplication operation and a first iteration of the iterative division algorithm, and selecting the normalized product during a second iteration of the iterative division algorithm.

20. The arithmetic unit of claim 18, wherein the at least one adder comprises:
a carry-save adder that adds an injected rounding bit vector to at least one of the plurality of values representing the product of the at least a portion of the first operand and the at least a portion of the second operand during the division operation; and
a carry-propagate adder that sums the plurality of values.
